(19) United States
(12) Patent Application Publication
(10) Pub. No.: US 2016/0380814 A1
(43) Pub. Date: Dec. 29, 2016

(54) SYSTEMS AND METHODS FOR PROVISIONING A BATTERY-POWERED DEVICE TO ACCESS A WIRELESS COMMUNICATIONS NETWORK

(71) Applicant: Roost, Inc., Sunnyvale, CA (US)

(72) Inventors: Roel Peeters, San Carlos, CA (US); James Blackwell, Los Gatos, CA (US); Mickey Nasiri, San Jose, CA (US); Lakshmi Girija, Santa Clara, CA (US)

(21) Appl. No.: 14/747,127

(22) Filed: Jun. 23, 2015

(51) Int. Cl. H04L 12/24

(52) U.S. Cl. CPC H04L 41/0806; H04W 84/12

(57) ABSTRACT

In some aspects, the present disclosure provides a method of associating a device with a wireless communications network. The method includes receiving a signal from a second device, the signal received using an element configured to sense at least one of sound or vibration. The method further includes interpreting the signal in order to determine one or more parameters for a wireless communications network. The method also includes associating with the wireless communications network, based at least in part on the one or more parameters.

### FIELD

The present disclosure relates generally to adding communications capability and sensing capability into battery-powered devices not having a native communications capability, more specifically, for accessing a wireless communication network.

### BACKGROUND

Many devices that did not traditionally have communications capabilities are being replaced by updated devices that do have native communications capabilities. For example, newer, more expensive smoke detectors have native communications capabilities. However, this does not help with other smoke detectors and it is typically more cost effective to reuse the existing smoke detector and add in communications capabilities.

In adding such functionality, cost of components and assembly are a consideration. Another consideration is power consumption, as in a normal lifetime of smoke detector battery, only a very small portion of that lifetime is spent in an alarm activated state.

### SUMMARY

In some aspects, the present disclosure provides a method of associating a device with a wireless communications network. The method includes receiving a signal from a second device, the signal received using an element configured to sense at least one of sound or vibration. The method further includes interpreting the signal in order to determine one or more parameters for a wireless communications network. The method also includes associating with the wireless communications network, based at least in part on the one or more parameters.

The following detailed description together with the accompanying drawings will provide a better understanding of the nature and advantages of the present invention.

### BRIEF DESCRIPTION OF THE DRAWINGS

FIG. 1 illustrates a novel battery-based device with integrated audio sensing using a passive sensor.

FIG. 2 is a rear view of a smoke detector that might use the battery-based device of FIG. 1.

FIG. 3 is a front view of a smoke detector that might use the battery-based device of FIG. 1.

FIG. 4 is an illustration of an exemplary signal that may be used according to some aspects of the present disclosure.

FIG. 5 is an exemplary illustration of an audio sweep signal that may be used according to some aspects of the present disclosure.

FIG. 6 is an illustration of a provisioning data format that may be used to provision the device.

FIG. 7 is an exemplary illustration of a payload that may be used according to some aspects of the present disclosure.

FIG. 8 is an exemplary method for associating a device with a wireless communications network according to some aspects of the present disclosure.

FIG. 9 is an exemplary method for provisioning a device to associate with a wireless communications network according to some aspects of the present disclosure.

Appendix A describes a chirp sequence.

### DETAILED DESCRIPTION

For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

In embodiments of devices explained herein, it may be desired to provide a mechanism whereby a device may connect to a wireless communications network, such as an IEEE 802.11-compatible network (a “Wi-Fi” network). However, in certain cases, the device may not include a user interface, or may include only a minimal user interface. Further, wireless communications networks may require certain information in order to allow a device to access those networks. For example, a network may require a service set identifier (SSID), a security type, a passphrase, and perhaps other data elements. Accordingly, it may be desired to provide this information to a device, such as a smart battery, that does not have a user interface and which may be configured to minimize power usage as much as possible.

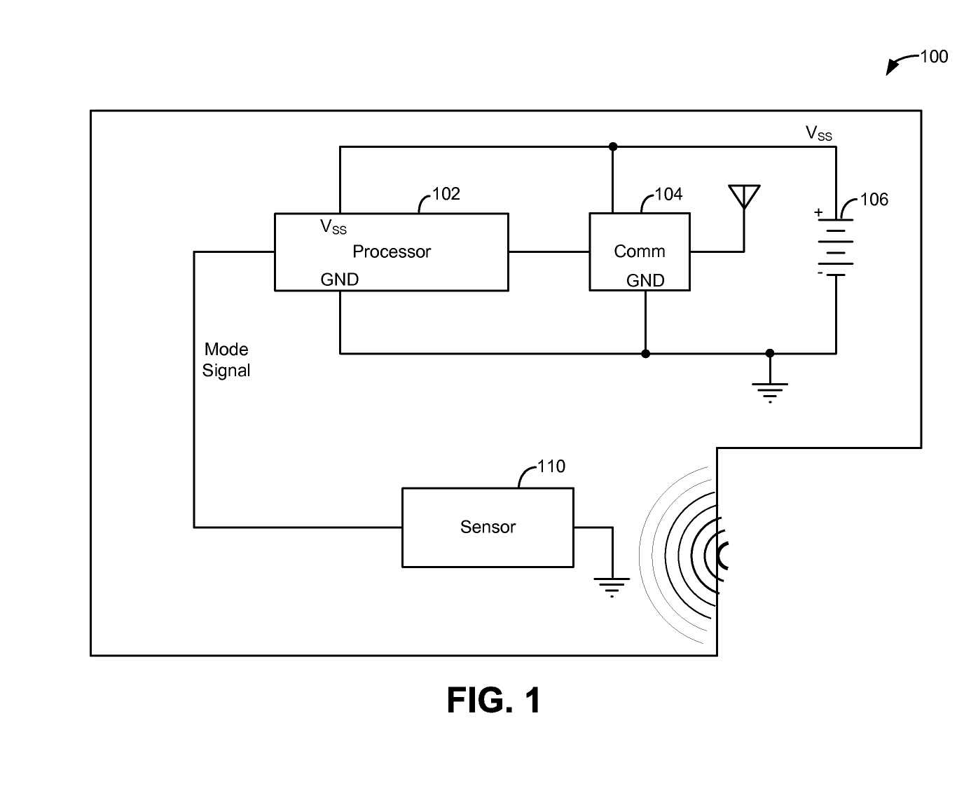

FIG. 1 is a schematic diagram showing various components of a device incorporating certain aspects of the present disclosure. As shown, a device 100 includes a processor 102, a communications module 104 (which might comprise an antenna and/or some control logic and analog circuit elements), a battery 106 for powering processor 102 and communications module 104. In other variations, processor 102 is replaced with a simpler control circuit. Processor 102 can be a microprocessor or microcontroller or system on a chip, as appropriate.

Battery 106 might be integrated into a housing such that all of device 100 would fit into a chamber sized to accept a conventional battery. Preferably, processor 102 has a sleep mode and an awake mode, wherein power consumption is reduced in the sleep mode relative to the awake mode. Processor 102 switches from the sleep mode to the awake mode in response to a signal received at a mode signal input to processor 102. A passive sensor 110 is coupled to the mode signal input of processor 102. Passive sensor 110 can be a sound sensor.

Passive sensor 110 might comprise a piezoelectric transducer, such as those used as electrically powered output devices that generate audio. Given the location of device 100 (inside or near a smoke detector or other alarm signaling device), the typical minimum sound level requirement for such detector/devices, and the form of the signal, the sound energy impinging on passive sensor 110 in an alarm condition is sufficient energy to generate the mode signal without needing any other electrical power.

By taking advantage of the piezoelectric property that the transducer can generate a voltage when excited by an audio signal, and the minimum sound levels expected at passive sensor 110, as well as the level of detail needed from the signal, device 100 can remain in its deepest sleep state, without the need to periodically wake-up to monitor the audio.

In a specific embodiment, a smoke detector has an alarm sound generator, such as a speaker that can generate an 85 dB alarm sound. Given the proximity of device 100 to the speaker, passive sensor 110 can generate enough excitation energy on its own to provide the mode signal, a voltage waveform that wakes processor 102. Once awake, processor 102 can monitor both the frequency and waveform period to determine if the cause of the wake-up was a real alarm. For example, processor 102 might maintain a set of lookup parameters that are compared to a continuing signal received at its mode signal input.

For ease of implementation, passive sensor 110 might be an audio transducer selected to have a resonant frequency close to, or at, the generated frequency of the alarm to increase the amplitude of the resulting output voltage waveform.

For many smoke detectors, the frequency and waveform of its audible alert is standard, such as those defined by ANSI specification ANSI/ASA S3.41-1990 (R2008) (Audible Emergency Evacuation Signal). ANSI specification ANSI/ASA S3.41-1990 (R2008) requires a specific pattern—referred to as “Temporal Three's”. This pre-defined pattern can be used to validate that the alarm is being generated by the smoke alarm.

To minimize false triggers, the period and the frequency of the alarm can be learned during an installation process. As part of the installation, the user might be requested to press an alarm “test” button. This would trigger the smoke alarm and processor 102 can use passive sensor 110 to learn both the frequency and pattern of the alarm. Later, this can be used as a base comparison to compare against any future alarms. Thus, if there were a match, processor 102 would send an alarm signal to communication module 104, which could then wirelessly transmit a corresponding message signaling the alarm.

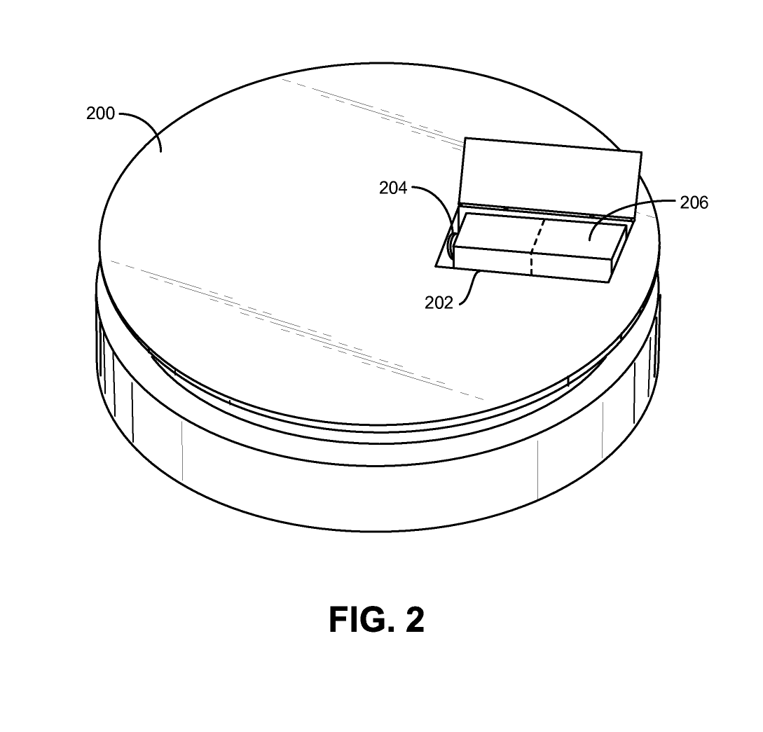

FIG. 2 illustrates how the circuits described above might be used within a conventional smoke detector housing. As illustrated there, smoke detector 200 has a battery compartment that might otherwise house a conventional 9V battery. In its place, is a housing containing a battery and the circuitry shown in FIG. 1. It might be that this housing has the circuity in a battery portion 202, terminals 204 for providing electrical power to smoke detector 200, and a battery portion 206 for providing power.

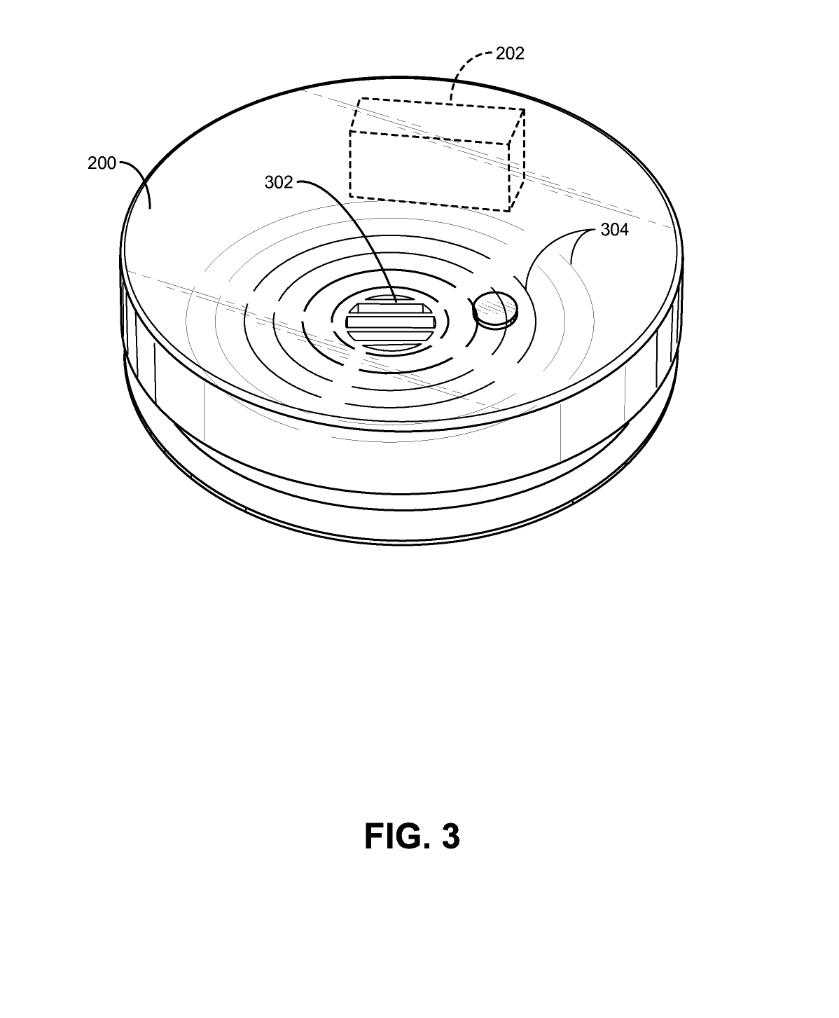

FIG. 3 illustrates how battery portion 202 (or all of the housing containing that portion) can be situated near enough to an alarm emitter 302 so that sound waves 304 are sufficient to power passive sensor 110 (shown in FIG. 1).

The device might also be used in other applications, such as a carbon monoxide detector or other alarm condition signaling system. The device might be used with various battery form factors, such as 9V, AA, AAA, ½ AA, N, or other form factors.

In some aspects, as described above, a low-power device may be desired, such as a device which might be accommodated in a conventional 9V battery compartment in a smoke detector. It may be desired for this device to be able to connect to a wireless communications network, such as a Wi-Fi network. For example, this may allow for online functionality, such as monitoring a status of the device, or allow the device to alert a user in the event that an alarm sounds.

In order to connect to a Wi-Fi network, the device must be given some amount of information. For example, a Wi-Fi network may be associated with a service set identifier (that is, the name of the Wi-Fi network), a security type, a passphrase, and possibly other data elements or information. This may be referred to as “provisioning” the device. Since the device may lack a user interface, provisioning may need to be done using a method other than through a user interface. Generally, it may be preferred to provision a device in a manner that is simple for an end user.

One possible way to provision a device is using a computer system, such as a smartphone with an app on it, to convey provisioning data to the device over a computer communications link. Generally, a smartphone or other system may already have all the information needed to access a wireless communications network, but still there is a need for a way to move that provisioning data to the device if the device does not already have some computer communications link capability.

A smartphone may already be provisioned to access the wireless communications network, and may have all information sufficient to access that network. Accordingly, it may not be necessary to input this information into the smartphone for the purpose of transmitting the data to the device, as the information may already be there. In some aspects, Wi-Fi provisioning data may be input into the smartphone using an app, in order to provide that data to the device. Accordingly, once this data is received by the smartphone app, either through user input or through previous knowledge of the smartphone, it may be desired for the smart phone or other device to pass this information along to the device.

As described above, the device may include a passive sensor, such as passive sensor 110. In some aspects, this passive sensor may be an element configured to receive one or more of sound and vibration. For example, the passive sensor may be a piezoelectric (PE) element that can be used to sense sound or vibration. This PE element may be the same element that may be used to, for example, detect when a smoke detector is going off. Accordingly, sound and vibration are two possible ways that a smartphone may convey information, such as provisioning information for a wireless communications network, to the device.

It may be desirable to receive such provisioning information using a passive sensor rather than another type of sensor. For example, the device may also have a traditional antenna, such as those used in other Wi-Fi devices. However, the device may not initially be aware of what Wi-Fi networks are in an area, or even of when the device is installed into a smoke detector or other type of application. Accordingly, if a device was to use an antenna to attempt to receive provisioning information, it may not be aware when such provisioning information may be received. Thus, the device may be required to keep such an antenna active, which may consume large amounts of power. Accordingly, it may be much more advantageous to provide provisioning information to the device using the passive sensor, such that the device may not need to use any power scanning for provisioning information.

One method of providing provisioning data to the device is to use vibration. In some aspects, the device may be pressed up against a smartphone. The device may either be pressed directly to a smartphone, or the device may be inserted into an appliance such as a smoke detector, and the smartphone may be pressed against the appliance. Generally, different amplitude signals may be needed in this different use cases. When using a vibrational pattern to transmit information, the smartphone may vibrate with the signal described in further depth below. The device may sense the vibrations using its sensor, and decodes the data.

Another method of provisioning data to the device is using sound. This sound may take different forms. For example, the sound may be played as a “plain audio” file, in which a smartphone plays an audio sequence that is picked up by the device. Generally, one potential downside of this approach may be that the audio sequence may be seen as being annoying to an end user. For example, this sequence may annoy a user if the audio file sounds like a traditional modem sound.

Thus, one option for provisioning a device using sound is to mix a data sequence with a music track. For example, data may be mixed into a song that is known to the device, and the data may be encoded into the song. The device may then be configured to filter out the data and to ignore the music track. This may allow the device to receive a signal, without annoying an end user by playing modem sounds. Accordingly, it may be advantageous to mask an audio signal into a song or other more user-pleasing sound.

The signal to the device may be a variable number of bits. For example, the signal may be anywhere from 100 to 1500 bits, or more. The signal may be in the form of a sync spike followed by a period of silence, with the length of the period of silence representing a bit. This form of transmission may help deal with the idea that clocks on the device and the smartphone may not be synced, amplitudes may not necessarily be controllable, and frequency responses of the PE element may vary quite a bit, depending on the expense and precision of the manufacturing techniques used. Accordingly, such a signal may be preferable in order to minimize manufacturing costs and in light of these other considerations.

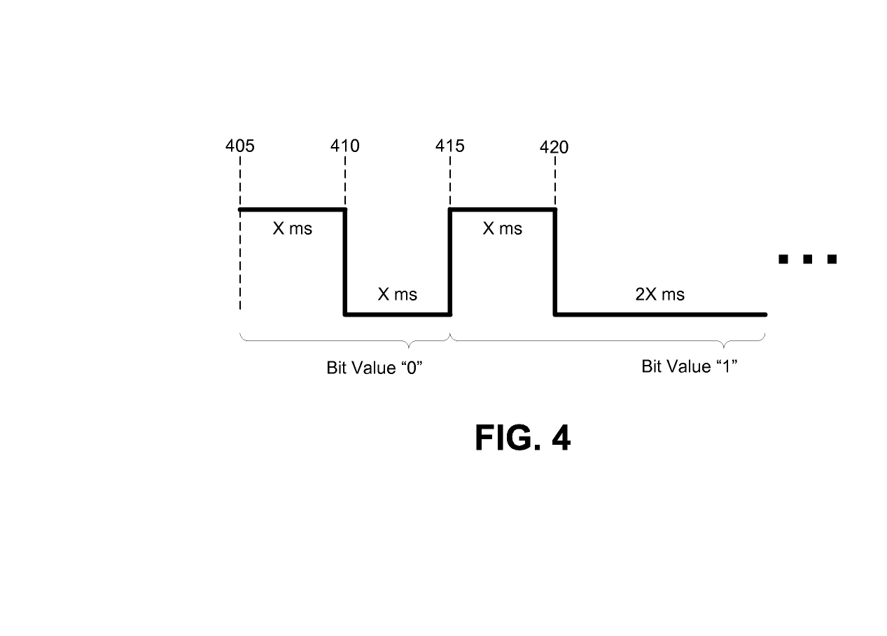

FIG. 4 is an illustration of an exemplary signal that may be used according to some aspects of the present disclosure. At time 405, an X ms noise spike may be transmitted. Here, the noise spike may be of any duration. The duration of this noise spike may be chosen in order to ensure that the spike is long enough to be received by a device. For example, the noise spike may be 1, 2, 5, 10, 12.5, 15, or 20 ms, or another value. This noise spike may be transmitted using sound, vibration, or another technique. The noise spike may then be followed by X ms of silence at time 410. This X ms of silence may represent a bit with a value of 0. Thus, a bit with a value of “0” may be indicated in 2X ms, by first transmitting a X ms noise spike followed by X ms of silence, before the next noise spike begins. As described herein, this noise spike and silence may be made up of audio signals, vibrations, or any other way of transmitting between a smartphone and the device. As illustrated, the representation of “1s” and “0s” uses a pulse-width modulation. These periods of different widths (durations) represent the value of the bit. Both “0s” and “1s” are represented with a series of sine waves (called chirps) followed by a silence period.

At time 415, another X ms noise spike may be transmitted, indicating the start of another bit. This X ms noise spike may be followed by 2X ms of silence at time 420, in order to indicate a bit with a value of 1. Accordingly, in some aspects, a bit with a value of “1” may be transmitted in 3X ms, before being followed by another bit. These times are merely exemplary and other times and formats may also be used. For example, the noise spikes and silences may be either longer or shorter, and the relative duration of the silence for 0 and 1 may be the opposite, such that a bit with a value of 0 takes either more or less time to transmit than a bit with a value of 1. As illustrated, each bit may take either 2X ms or 3X ms to transmit, depending on the value of the bit. In some aspects, when X is 12.5 ms, approximately 27-40 bits may be transmitted per second, and it may take approximately 20 seconds to signal the provisioning data to a device. In some aspects, 12.5 ms of silence may correspond to 551 samples, while 25 ms of silence may correspond to 1102 samples. These sample rates may correspond to the number of samples when using a stereo WAV file, with a sample rate of 44,100 Hz. Note that while FIG. 4 illustrates that a bit with one value may have a silence that is twice as long as a bit with the other value, this ratio need not be used. For example, in some aspects, a bit with a value of 1 may use a silence that is 0.33, 0.5, 0.75, 1.5, 2, or 3 times the length of the silence of a bit with a value of 0, or may use another ratio.

Generally, the resonant frequency of a PE element may vary over different manufacturing variations. Accordingly, different PE elements may have center frequencies of anywhere from 2700 Hz to 3700 Hz, or perhaps 2400 Hz to 4000 Hz. To account for these variations, it may be desirable for an initial sync noise spike to be a tone that starts at the lower end of this frequency range and sweeps to the higher end of this frequency range. Starting at the lower frequency may be desirable in some aspects, since this may allow the PE element to begin vibrating, since there is some inertia in sound detection in a PE element.

Further, there may also be some inertia at the other end as well. That is, the PE element may take some period of time to begin vibrating, and may also take some period of time to stop vibrating after it begins vibrating. Accordingly, the spacing of the noise spikes and the silence should be sufficient to allow “0” and “1” bits to be accurately distinguished from one another, accounting for this inertia.

One method of transmitting provisioning data may include using masked audio. This may begin by starting with some audio. If the audio has a signal in the range of 2400 Hz to 4000 Hz, this sound may be removed from the audio, such as by filtering it out. These frequency ranges may be either prefiltered, or filtered on the fly, as might be the case where the audio is custom audio, such as if a user is permitted to use their own chosen audio. Certain sound tracks may sound much better than others when these frequency ranges are filtered. For example, a sound track with a drum and bass may be good, as most of the sounds would be low frequency, with some sounds above 4000 Hz. A track with singing is unlikely to sound good when audio between 2400 Hz and 4000 Hz is removed, for example.

After an audio track with no signal between 2400 to 4000 Hz is obtained or created, the data signal may be mixed into the audio track, and an amplitude that is dominated by the music. For example, the data may be transmitted using sync pulses sweeping from 2400 Hz to 4000 Hz, followed by silence, for X ms or 2X ms, then repeated until the data signal is complete. The device may be configured to filter out all the sound except for that between 2400 to 4000 Hz. In some aspects, this filtering may be done by using a PE element that has only a limited range of sensitivity. For example, if, as described above, the PE element is sensitive only to one or more frequencies within the range of 2400 Hz to 4000 Hz, and to no frequencies outside this range, the PE element may respond only to the frequencies found in the data signal, and not in the rest of the audio track.

Due to the sweep of the audio signal, frequency calibration may not be needed. If the frequency sensitivity of the PE element varies from a central frequency (of the 2400 Hz to 4000 Hz range), since the sweep is always of the same duration and the same direction (low to high), a shift in the sensing frequency of the PE element from device to device would correspond to a fixed shift in time of detecting the sync pulse. Accordingly, such sensitivity differences would not cause difficulties in receiving the signal, as the each pulse would appear identically to a particular given device, as compared to other pulses to the same device. This ability to compensate for different central frequencies of a PE element may allow for less costly and precise manufacturing methods to be made, and may allow for devices which can more reliably be provisioned to be constructed for less expensive amounts.

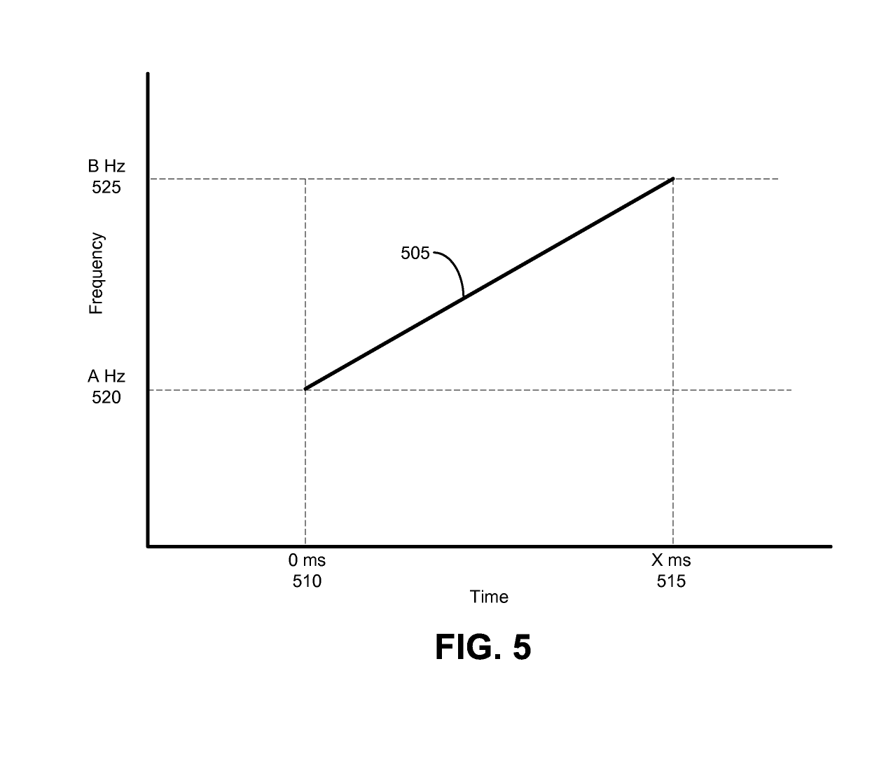

FIG. 5 is an exemplary illustration of an audio sweep signal that may be used according to some aspects of the present disclosure. At time 510, an audio signal 505 begins. This signal may be transmitted at A Hz 520. The audio signal 505 may last until time 515, corresponding to X ms after time 510. The audio signal 505 may slowly sweep from A Hz 520 to B Hz 525 during this X ms period of the audio signal, as illustrated. In some aspects, the values of A and B may be based on frequency ranges at which the device may receive a signal. For example, it may be that a device, based on the methods of manufacturing and other characteristics, might respond to signals at some frequency in the range of 2700 Hz to 3700 Hz, for example. Accordingly, A and B may be chosen in order to include this range, such as spanning from, e.g., 2200, 2400, or 2600 Hz or another value to 3800, 4000, or 4200 Hz, or another value. Other values of A and B may also be used, depending upon the response ranges of various devices.

In some aspects, the device may include an accelerometer. For example, the accelerometer may include a microelectromechanical systems (MEMS) accelerometer. If the device includes an accelerometer, that could also be used for providing the device with provisioning data. The accelerometer may be configured to sense vibrations from the smartphone. Further, the accelerometer can be used to sense whether the device is being moved, and movement might trigger the device to test whether it is still installed in a smoke detector. If the device determines it is not still installed in a smoke detector, the device may send the appropriate alerts. For example, if the device detects that it is moving and keeps moving for 10 minutes or more, that might be a suitable indication that the device is not installed in a smoke detector affixed to a surface. In that case, the device might send an alert to a URL and/or to a smartphone app interface with the message “Warning, smart battery might not have been inserted into smoke detector or smoke detector is in motion unexpectedly.”

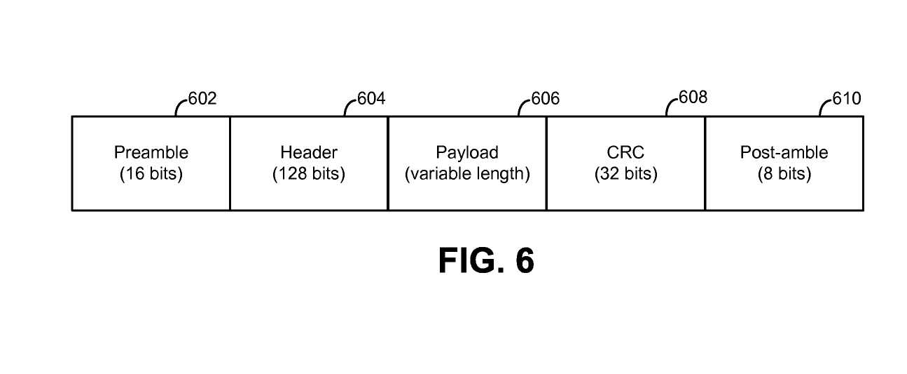

Generally, provisioning the device may be done by providing data to the device. FIG. 6 is an illustration of a provisioning data format that may be used to provision the device. The provisioning data may include a preamble 602, a header 604, a payload 606, a cyclic redundancy check (CRC) 608, and a post-amble 610. The bits may be ordered in Little-Endian format, such that the least significant bit corresponds to b0, and this is the first bit to be sent. Thus, a first bit of the preamble may be the first bit to be sent.

A packet, such as provisioning data that is contained in a packet, may end with a post-amble 610. The post-amble 610 may be 8 bits in length, although other lengths are also possible. Generally, the post-amble 610 may include data which takes the form of:

Post-amble=11111111_{LSB}

As described earlier, this data may be transmitted in Little-Endian format, such that the least significant bit (LSB) is found in the lowest register address, as bit 0.

Each packet may begin with a preamble 602. In some aspects, the preamble 602 may include 16 bits, although other sizes of preamble 602 are also possible. The preamble 602 may include values that alternate between “0” and “1”, but which begin with a “1.” The last two bits of the preamble may both be “1s.” For example, the preamble 602 may be:

Preamble=11010101 01010101_{LSB}

The header 604 may be made up of 128 bits. As before, other sizes may also be used for the header 604. The header 604 may be transmitted after the preamble 602. The header 604 may include a number of fields, as illustrated in Table 1, below. Note that the length of each field listed below is merely exemplary, and other lengths may also be used.

TABLE 1

| | | Value in | |
|---|---|---|---|
| | Length | software | |
| Field | (Bits) | version 1 | Notes |
| Version | 32 | 1 | This field allows for upgrade of the design. Initially, the version |
| | | | will be set to 1 |
| Total | 32 | Number of | This field allows for payloads longer than 1,024 bits. Initially, it |
| Payload | | bits in the | will be set to the total number of bits in the payload. If this |
| Length | | payload | design is required to transport data that requires more than |
| | | (max 1024) | one packet, this field will contain the total number of bits of |
| | | | data being transported. |
| Payload | 8 | 0 | This field allows for payloads longer than 1,024 bits. Initially, it |
| Number | | | will be set to 0. For subsequent versions, it will contain a |
| | | | counter to enable reconstruction of payloads that span multiple |
| | | | packets. |
| Payload | 24 | Number of | This field allows for payloads longer than 1,024 bits. Initially, it |
| Length | | bits in the | will be set to the total number of bits in the payload in this |
| | | payload | packet. (Set equal to Total Payload Length) |
| Reserved | 32 | 0 | This field is unused in version 1. |

The header 604 may include a version field, which may be 32 bits. This field may be used to indicate a version of the software that is being used in the header 604. For example, in some aspects, the version field may indicate that version 1 is being used.

The header 604 may also include a total payload length field. The total payload length field may be used to indicate a number of bits in the payload of the packet. This field may be 32 bits, which may allow it to signal up to 1024 bits. If the payload is larger than 1024 bits, more than one packet may be used, and this field may contain the total number of bits of data being transported.

The header 604 may also include an 8-bit payload number field. This field allows for payloads longer than 1024 bits. In some versions, this field may be set to 0. This field may also be configured to contain a counter, which may allow for reconstruction of payloads that span multiple packets.

The header 604 may also include a 24 bit payload length field. This field may indicate the number of bits in the payload, and may allow for payloads longer than 1024 bits. Initially, this value may be set to the total number of byes in the payload in this packet, while the total payload length is set to the total number of bits in all packets.

The head 604 may also include 32 bits which are reserved for future use. These bits may be used later for any purpose.

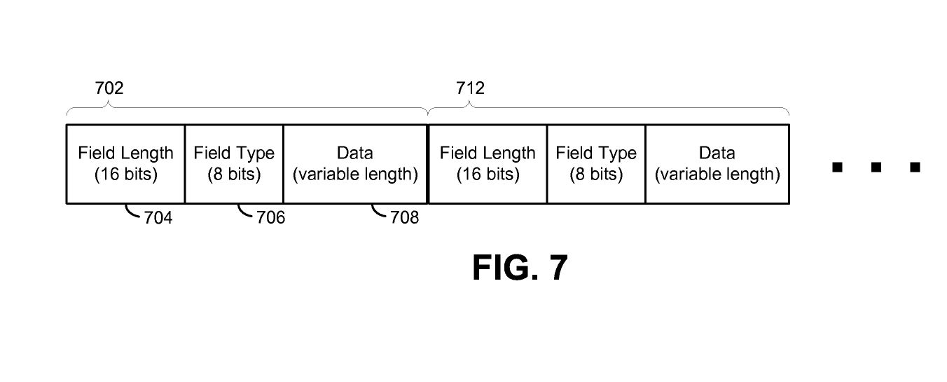

In some aspects, the payload 606 may have a variable length, and may be divided into several different sections. FIG. 7 is an exemplary illustration of a payload 606 that may be used according to some aspects of the present disclosure. The payload 606 includes multiple sections 702, 712. While two sections are illustrated, there may also be other sections of the payload.

Each section of the payload may include a 16-bit field length field. The length of this field is merely exemplary, and other lengths may also be used. For example, section 702 of the payload may include a field length field 704 that is 16 bits. The field length field 704 may describe the length of the section of the payload, including field length field 704, field type 706, and data 708.

The field type field 706 may have one of a number of field type codes. Table 2, below, illustrates possible field type codes that may be used in the field type field 706.

TABLE 2

| Field Type | | |
|---|---|---|
| code | Field Type | Details |
| 01 | SSID | The SSID of the provisioning Wifi Network |
| 02 | AP Password | The password of the provisioning |
| | | Wifi Network |
| 03 | Object ID | An unique identifier that identifies the |
| | | sensor/battery retrieved from Cloud |
| 04-FF | Reserved for | Reserved for future use |
| | future use | |

As illustrated, different field type codes may be contained in the field type field 706. For example, a field type code may indicate the content of the data 708. For example, field type codes may be used to indicate field types including a SSID of a wireless communications network, an Access Point (AP) password in order to access the wireless communications network, or an Object ID, which may be a unique identified that identifies the device (which might be a sensor or a battery), where the Object ID is received from a server in the cloud. Other field type codes may also be possible, and other values may be reserved for potential future uses.

In some aspects, it may be useful to encrypt provisioning data, in order to limit the transmission of wireless communications network access credentials, and to reduce or eliminate the chance of these credentials being overheard by another device. In some aspects, it may also be beneficial to transmit provisioning data with Forward Error Correction (FEC) in the signal. For example, a Hamming Code FEC may be used for this purpose. Generally, FEC may be useful in order to control errors in transmitting the provisioning data, and may allow the device to detect or correct errors in the transmission of the data due to redundancies.

To generate the provisioning signal, once the preamble, headers, payload, and CRC are created in binary format, a WAV file may be created where each bit starts with a chirp, followed by a silence period. Appending the chirp period and the corresponding silence periods listed in Appendix A will generate the final audio signal for provisioning.

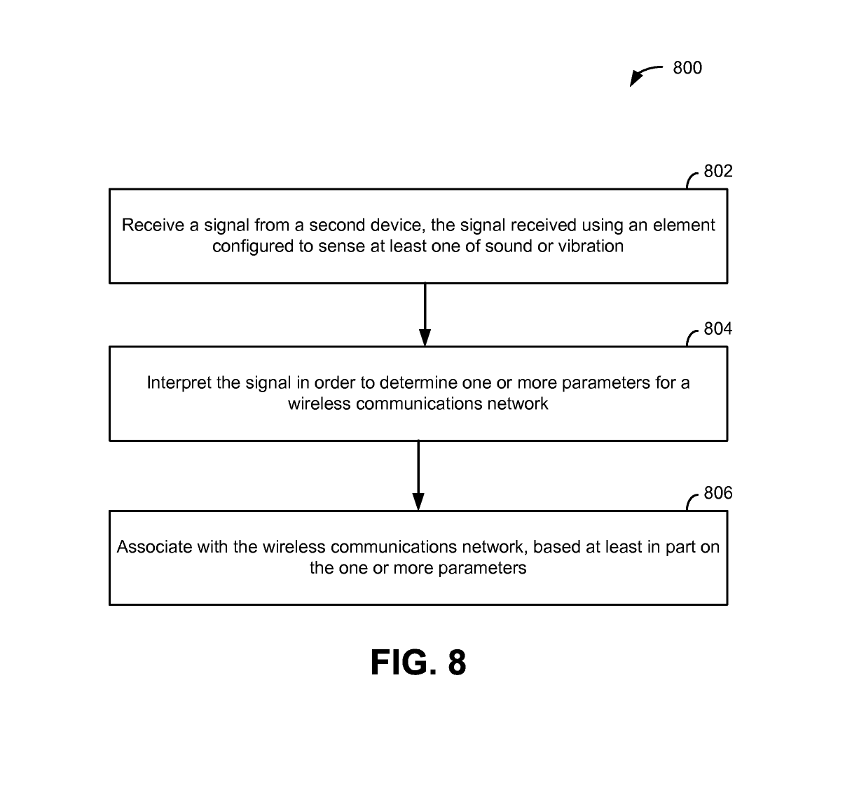

FIG. 8 is an exemplary method 800 for associating a device with a wireless communications network according to some aspects of the present disclosure. This method may be carried out on a device, such as a smart battery or other type of device described herein.

At block 802, the device receives a signal from a second device, the signal received using an element configured to sense at least one of sound or vibration. In some aspects, the signal may be a vibration and the element may be configured to sense vibrations. For example, the signal may be transmitted by a smartphone or another device, using that device's vibration ability. In some aspects, the signal may include a sound, and the element may be configured to play a sound. For example, the sound may be a plain sound, or a sound signal that is masked within a song or other melody, such as including a sound signal in a certain frequency range while playing a louder melody or song in other portions of the frequency spectrum. In some aspects, the element may be a piezoelectric element or a microelectromechanical element.

At block 804, the device interprets the signal in order to determine one or more parameters for a wireless communications network. In some aspects, the wireless communications network may be a Wi-Fi network, and the parameters may include one or more of an SSID, a security type, and a passphrase for the network. In some aspects, the signal may include a packet, and the packet may include a preamble, a header, a payload, a cyclic redundancy check, and a post-amble. In some aspects, the signal may include the one or more parameters for a wireless communications network, and the one or more parameters for a wireless communications network may be encrypted in the signal. In some aspects, interpreting the signal may include using a frequency band filter in order to filter out frequency ranges in which the song or other melody is played in order to isolate the sound signal. For example, the frequency band filter may filter out sounds that are below A Hz (such as 2200, 2400, or 2600 Hz) and/or above B Hz (such as 3800, 4000, or 4200 Hz). In some aspects, this filtering may be done using software, or this filtering may be done automatically based on the capabilities of the hardware. For example, a PE element may be used that is configured to respond only to frequencies in a certain portion of a frequency range.

At block 806, the device associates with the wireless communications network, based at least in part on the one or more parameters. For example, the device may be configured to use one or more of an SSID, a security type, and a passphrase in order to associate with a Wi-Fi network.

In some aspects of the present disclosure, a device configured to associate with a wireless communications network based on provisioning data is described. The device includes an element configured sense at least one of sound or vibrations, and a processor configured to receive a signal from a second device using the element, interpret the signal in order to determine one or more parameters for the wireless communications network, and associate with the wireless communications network, based at least in part on the one or more parameters. In some aspects, the signal may include a vibration, and the element may be configured to sense vibration. The signal may also include a sound, and the element may be configured to sense sound. The sound may include a sound signal that is masked within a song or other melody, and the processor may be configured to interpret the signal using a frequency band filter in order to filter out frequency ranges in which the song or other melody is played in order to isolate the sound signal. The element may be one of a piezoelectric element and a microelectromechanical element. The one or more parameters may include at least one of a service set identifier, a security type, and a passphrase. The wireless communication network may be a Wi-Fi network. The signal may be transmitted as a packet, and the packet may include a preamble, a header, a payload, a cyclic redundancy check, and a post-amble.

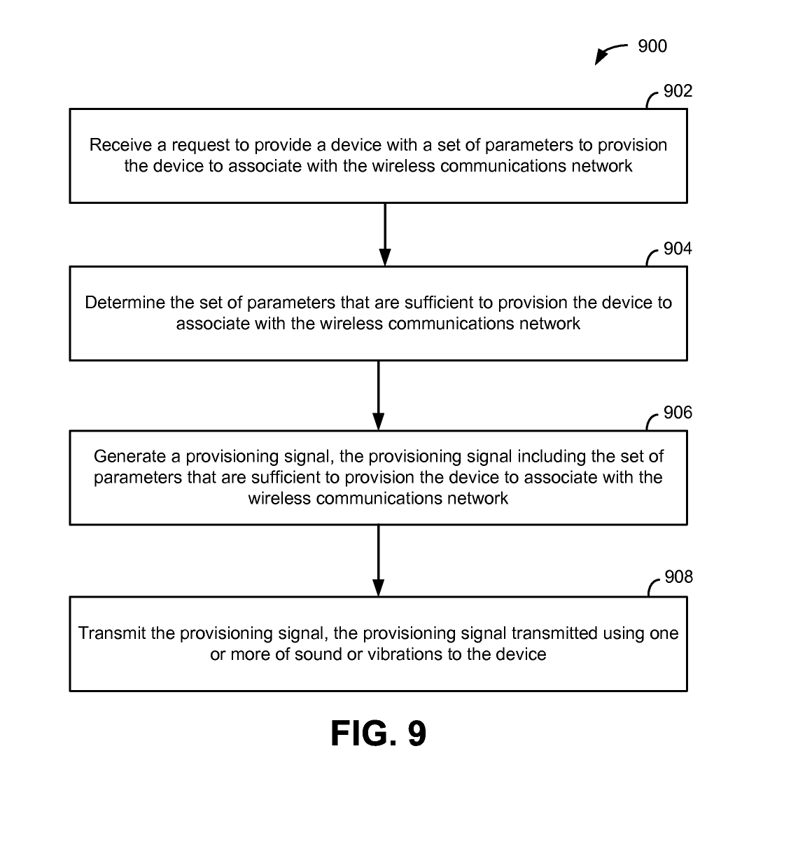

FIG. 9 is an exemplary method 900 for provisioning a device to associate with a wireless communications network according to some aspects of the present disclosure. This method may be carried out on a device, such as a smartphone, in order to provision another device, such as a smart battery.

At block 902, the device receives a request to provide the device with a set of parameters to provision the device to associate with the wireless communications network. In some aspects, receiving a request may include receiving input from a user in an app on the device.

At block 904, the device determines the set of parameters that are sufficient to provision the device to associate with the wireless communications network. In some aspects, the set of parameters may include at least one of a service set identifier, a security type, and a passphrase, and the network may be a Wi-Fi network. For example, a device may use the name of a Wi-Fi network (the SSID), and a passphrase and a security type to associate with that network.

At block 906, the device generates a provisioning signal, the provisioning signal including the set of parameters that are sufficient to provision the device to associate with the wireless communications network. In some aspects, generating the provisioning signal may include generating a stereo WAV file with a sample rate of 44,100 Hz. For example, the provisioning signal may be a sound, and this sound may include either just the provisioning data or may include the provisioning data masked in other sound data. For example, the provisioning data may be included in a range of approximately A Hz to B Hz, and other portions of the frequency spectrum may contain music or other melodies, in order to mask the provisioning data and to potentially make the sound less annoying to an end user (less like modem sounds). This provisioning data may be an audio sweep signal, as illustrated in FIG. 5, which increases in frequency. In some aspects, generating the provisioning signal may include generating at least a preamble, deader, payload, and cyclic redundancy check in binary format, and each bit in the provisioning signal may include a chirp followed by a silence period. In some aspects, the chirp may be an X ms chirp, and wherein the silence period for each bit may be either X ms or 2X ms, depending upon the value of the bit. For example, X may be 12.5 ms, or may be 5 mx, 10 ms, 15 ms, or 20 ms. In some aspects, X may be a predetermined value within a certain range, such as between 2 ms and 20 ms. In some aspects, the minimum of this range may be constrained by how long it would take for a device to recognize the signal and the amount of expected variations in the signals (i.e., the noise level). In some aspects, the maximum of this range may be constrained by the length of training that is acceptable to an end user. For example, if signals have a longer duration, this may require a greater amount of time to transmit the provisioning data. In some aspects, the chirp may include a sound that begins at between 2200 Hz and 2800 Hz and may increase in frequency to end between 3600 Hz and 4200 Hz. For example, the chirp may begin at about 2400 Hz and may increase in frequency to approximate 4000 Hz, as described above. In some aspects, the provisioning signal may include a sound, and generating the provisioning signal may include masking provisioning data within a song or other melody to create the provisioning signal.

At block 908, the device transmits the provisioning signal, the provisioning signal transmitted using one or more of sound or vibrations to the device.

Using the above concepts, users of devices and sellers of such devices or sellers of combined battery/communications elements might have the systems set up so that alarm conditions can be detected without significant quiescent power drain.

The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Further embodiments can be envisioned to one of ordinary skill in the art after reading this disclosure. In other embodiments, combinations or sub-combinations of the above-disclosed invention can be advantageously made. The example arrangements of components are shown for purposes of illustration and it should be understood that combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

All references, including publications, patent applications, and patents, cited herein are hereby incorporated by reference to the same extent as if each reference were individually and specifically indicated to be incorporated by reference and were set forth in its entirety herein.

### Appendix A

[0,10779, 20380, 27716, 31941, 32555, 29461, 22988, 13854, 3098, −8041, −18270, −26379, −31400, −32715, −30142, −23961, −14889, −4001, 7397, 17920, 26275, 31419, 32696, 29919, 23408, 13951, 2719, −8881, −19381, −27432, −31987, −32435, −28693, −21216, −10955, 762, 12405, 22434, 29505, 32655, 31437, 25985, 17009, 5704, −6402, −17657, −26507, −31713, −32528, −28811, −21052, −10316, 1898, 13869, 23889, 30512, 32765, 30295, 23430, 13140, 909, −11479, −22202, −29660, −32724, −30910, −24459, −14312, −1982, 10673, 21727, 29478, 32713, 30906, 24307, 13911, 1322, −11499, −22534, −30027, −32765, −30283, −22948, −11908, 1073, 13907, 24502, 31115, 32636, 28785, 20168, 8185, −5183, −17711, −27286, −32278, −31813, −25940, −15628, −2620, 10863, 22495, 30250, 32755, 29543, 21143, 9006, −4745, −17680, −27489, −32403, −31509, −24938, −13846, −219, 13471, 24722, 31455, 32403, 27359, 17226, 3864, −10244, −22454, −30454, −32706, −28753, −19312, −6161, 8195, 20998, 29762, 32764, 29387, 20258, 7136, −7412, −20521, −29581, −32766, −29408, −20145, −6812, 7919, 21071, 29958, 32742, 28821, 18966, 5180, −9701, −22592, −30791, −32558, −27489, −16616, −2210, 12688, 24908, 31824, 31924, 25153, 12936, −2103, −16710, −27694, −32630, −30403, −21467, −7767, 7679, 21440, 30430, 32608, 27450, 16085, 1057, −14235, −26304, −32371, −31013, −22505, −8781, 7001, 21179, 30433, 32570, 27054, 15147, −362, −15809, −27515, −32662, −29985, −20090, −5331, 10740, 24228, 31831, 31662, 23726, 9938, −6323, −21044, −30557, −32466, −26258, −13453, 2757, 18296, 29223, 32740, 27915, 15945, −133, −16202, −28110, −32756, −28899, −17504, −1516, 14892, 27407, 32707, 29357, 18206, 2190, −14434, −27213, −32695, −29367, −18091, −1889, 14849, 27557, 32738, 28933, 17151, 613, −16118, −28391, −32764, −27978, −15336, 1639, 18175, 29589, 32617, 26359, 12563, −4851, −20895, −30939, −32053, −23875, −8743, 8959, 24065, 32131, 30754, 20299, 3823, −13810, −27356, −32753, −28348, −15425, 2161, 19118, 30306, 32302, 24457, 9129, −9016, −24415, −32309, −30227, −18772, −1467, 16317, 29024, 32648, 26011, 11163, −7232, −23359, −32078, −30580, −19300, −1817, 16272, 29138, 32597, 25490, 10084, −8628, −24544, −32431, −29665, −17113, 1111, 18991, 30579, 31987, 22704, 5798, −13076, −27568, −32761, −26857, −11820, 7262, 23887, 32350, 29710, 16834, −1871, −19951, −31126, −31477, −20841, −2896, 16086, 29431, 32407, 23923, 6942, −12528, −27554, −32746, −26205, −10237, 9438, 25727, 32715, 27828, 12801, −6917, −24127, −32501, −28924, −14672, 5024, 22880, 32249, 29607, 15895, −3787, −22071, −32062, −29957, −16509, 3220, 21747, 31999, 30023, 16533, −3327, −21929, −32078, −29814, −15969, 4108, 22604, 32277, 29299, 14797, −5555, −23734, −32530, −28415, −12981, 7652, 25245, 32731, 27062, 10476, −10361, −27024, −32729, −25115, −7242, 13613, 28908, 32333, 22436, 3258, −17290, −30681, −31318, −18889, 1452, 21207, 32071, 29436, 14368, −6797, −25101, −32748, −26440, −8826, 12587, 28619, 32348, 22123, 2320, −18510, −31318, −30497, −16360, 4951, 24113, 32692, 26870, 9171, −12607, −28811, −32214, −21254, −782, 20060, 31916, 29417, 13644, −8315, −26528, −32707, −23998, −4327, 17342, 31082, 30551, 15946, −6035, −25246, −32766, −25062, −5672, 16385, 30795, 30773, 16281, −5896, −25311, −32763, −24677, −4848, 17310, 31222, 30199, 14685, −7905, −26708, −32627, −22756, −1834, 20000, 32108, 28543, 11002, −11953, −29053, −31852, −18922, 3386, 24035, 32755, 25162, 4997, −17686, −31522, −29526, −12655, 10620, 28544, 32012, 19217, −3375, −24267, −32766, −24479, −3610, 19135, 32031, 28379, 10020, −13557, −30102, −30966, −15650, 7875, 27290, 32370, 20395, −2361, −23889, −32765, −24235, −2788, 20165, 32354, 27211, 7448, −16341, −31337, −29409, −11549, 12594, 29910, 30937, 15068, −9061, −28243, −31918, −18018, 5837, 26486, 32475, 20435, −2986, −24763, −32722, −22367, 545, 23171, 32762, 23868, 1464, −21787, −32685, −24991, −3038, 20669, 32561, 25782, 4174, −19856, −32445, −26279, −4877, 19374, 32372, 26506, 5149, −19239, −32363, −26477, −4993, 19454, 32420, 0].

What is claimed is:

1. A method of associating a device with a wireless communications network, the method comprising:
receiving a signal from a second device, the signal received using an element configured to sense at least one of sound or vibration;
interpreting the signal in order to determine one or more parameters for a wireless communications network; and
associating with the wireless communications network, based at least in part on the one or more parameters.

2. The method of claim 1, wherein the signal comprises a vibration, and wherein the element is configured to sense vibration.

3. The method of claim 1, wherein the signal comprises a sound, and wherein the element is configured to sense sound.

4. The method of claim 3, wherein the sound includes a sound signal that is masked within a song or other melody.

5. The method of claim 4, wherein interpreting the signal includes using a frequency band filter in order to filter out frequency ranges in which the song or other melody is played in order to isolate the sound signal.

6. The method of claim 1, wherein the element is one of a piezoelectric element and a microelectromechanical element.

7. The method of claim 1, wherein the one or more parameters include at least one of a service set identifier, a security type, and a passphrase.

8. The method of claim 1, wherein the signal includes a packet, and the packet includes a preamble, a header, a payload, a cyclic redundancy check, and a post-amble.

9. A device configured to associate with a wireless communications network based on provisioning data, the device comprising:
an element configured sense at least one of sound or vibrations; and
a processor configured to:
receive a signal from a second device using the element;
interpret the signal in order to determine one or more parameters for the wireless communications network; and
associate with the wireless communications network, based at least in part on the one or more parameters.

10. The device of claim 9, wherein the signal comprises a sound, and wherein the element is configured to sense sound.

11. The device of claim 10, wherein the sound includes a sound signal that is masked within a song or other melody.

12. The device of claim 11, wherein the processor is configured to interpret the signal using a frequency band filter in order to filter out frequency ranges in which the song or other melody is played in order to isolate the sound signal.

13. The device of claim 9, wherein the one or more parameters include at least one of a service set identifier, a security type, and a passphrase.

14. The device of claim 9, wherein the wireless communication network comprises a Wi-Fi network.

15. The device of claim 9, wherein the signal includes a packet, and the packet includes a preamble, a header, a payload, a cyclic redundancy check, and a post-amble.

16. A method of provisioning a device to associate with a wireless communications network, the method comprising:
receiving a request to provide the device with a set of parameters to provision the device to associate with the wireless communications network;
determining the set of parameters that are sufficient to provision the device to associate with the wireless communications network;
generating a provisioning signal, the provisioning signal including the set of parameters that are sufficient to provision the device to associate with the wireless communications network; and
transmitting the provisioning signal, the provisioning signal transmitted using one or more of sound or vibrations to the device.

17. The method of claim 16, wherein receiving a request includes receiving input from a user in an app on the device.

18. The method of claim 16, wherein generating the provisioning signal includes generating a stereo WAV file with a sample rate of 44,100 Hz.

19. The method of claim 16, wherein generating the provisioning signal includes generating at least a preamble, deader, payload, and cyclic redundancy check in binary format, and where each bit in the provisioning signal includes a chirp followed by a silence period.

20. The method of claim 19, wherein the chirp is a 12.5 ms chirp, and wherein the silence period for each bit is either 12.5 ms or 25 ms, depending upon the value of the bit.

21. The method of claim 19, wherein the chirp comprises a sound that begins at between 2200 Hz and 2800 Hz and increases in frequency to end between 3600 Hz and 4200 Hz.

22. The method of claim 16, wherein the provisioning signal comprises a sound, and wherein generating a provisioning signal includes masking provisioning data within a song or other melody to create the provisioning signal.
